(19) United States
(12) Patent Application Publication
(10) Pub. No.: US 2017/0075534 A1
(43) Pub. Date: Mar. 16, 2017

(54) METHOD OF PRESENTING CONTENT TO THE USER

(71) Applicant: Nikolay LESCHENKO, Kharkiv (UA)

(72) Inventor: Nikolay LESCHENKO, Kharkiv (UA)

(21) Appl. No.: 15/043,119

(22) Filed: Feb. 12, 2016

(30) Foreign Application Priority Data
Sep. 15, 2015 (UA) U201508961

(51) Int. Cl. G06F 3/0485; G06F 3/0487; G06F 3/0484

(52) U.S. Cl. CPC G06F 3/0485; G06F 3/04842; G06F 3/0487

(57) ABSTRACT

A method of presenting content to the user including the following steps: definition of a set of content elements, as well as of a set of content element groups, display on the screen of the electronic device of at least one content element of, at least one content element group, scrolling the set of content elements located in a certain content element group in one direction, where the content elements from the next or previous content element group are displayed immediately after receiving scrolling command in the other direction orthogonal to scrolling direction of the set of content elements from the current group.

The current application claims a foreign priority to application number u201508961 filed on Sep. 17, 2015 in Ukraine.

The solution relates to a method of presenting information, in particular method of displaying content elements on the screen of electronic device with a graphical interface based on user actions.

Due to a significant increase in capacity of storage media and electronic devices arranged with the ability of storing content elements, they can store a large number of various content elements sorted out in various directories (content element groups).

Interfaces of programs for electronic devices in many cases provide the user with multiple navigation commands and/or tools to move from one content element group to another and to view content elements in these groups on the device screen. For example, in order to move to the desired content element group a content element group tree is used. After viewing content elements in one group, the other group is displayed using a set of navigation tool commands “one level up” or going over every element and moving through content element group tree, and so on. Such a transition and display of the necessary content elements to the user require using some additional commands.

Consequently, it is necessary to provide a method that allows quickly and with fewer operations move from one content element group to another displaying their content on the screen of the device, which has fewer input or output operations and allows reducing operating time of the electronic devices' hardware making navigational transitions and thus reducing loading at least on the device's CPU and memory modules, which in turn would reduce energy consumption and extend battery life of the device.

The problem is solved by the method comprising the following steps: definition of a set of content elements, as well as of a set of content element groups, display on the screen of the electronic device of at least one content element of, at least one content element group, scrolling the set of content elements located in a certain content element group in one direction, where the content elements from the next or previous content element group are displayed immediately after receiving scrolling command in the other direction orthogonal to scrolling direction of the set of content elements from the current group.

In this case, on the screen of the device can be displayed either first element of the content of new group or element, the position of which in the group corresponds to the position of the element in the previous group, or element preselected for quick review in this group, or element, the type of which matches the type of the element of the previous group.

One of the improvements of this method is that when scrolling content elements it occurs a normalization of diagonal navigational movements and selection of scrolling direction depending on the angle of the diagonal navigational movement.

Another improvement of the method is that the content element from a group of elements can be displayed after its selecting by the user in additional area, in which a set of thumbnails of content elements of the current group is represented.

Additionally, content element group can be displayed after its selecting in another area, in which a set of thumbnails and/or names of content element groups is represented.

In this case, thumbnail area is displayed continuously or after user's command and the thumbnails of the content elements and the thumbnails of the content element groups can be scrolled along a continuous trajectory.

Further improvement of the method is that the set of content elements and set of content element groups can be scrolled along a continuous trajectory.

Another improvement of the method is that the content element can be displayed at least on a portion of the screen area of the electronic device, and in the rest of the screen area, it can be displayed an information as to the content element.

The alternative is that the content element is displayed on the full area of the electronic device screen, and information as to the content element can be displayed upon user's request, above content element.

Thus, by reducing the number of operations to be performed by the electronic device the load on the CPU and battery unit is reduced and input or output of information to the electronic device screen is accelerated.

This method can be applied in electronic devices, which include a gyroscope, where a set of content elements and/or set of content element groups can be scrolled by tilting the electronic device.

In the case of applying this method in electronic devices that include a touch screen or touch pad, a set of content elements and/or a set of content element groups is scrolled by recognition of the user's single gestures and/or multiple touch gestures.

This method is also used in electronic devices controlled by at least one of the input devices, such as keyboard, mouse, joystick, remote control.

The set of content elements and/or set of content element groups also can be scrolled by the user's voice command recognition.

Additional idea of this solution is that while navigating a minimum of “secondary” control elements is displayed to the user, and the content of at least one element of the current content element group is displayed to the forefront.

For more details about the solution please see the exemplary embodiment which refers to the accompanying drawings, in which:

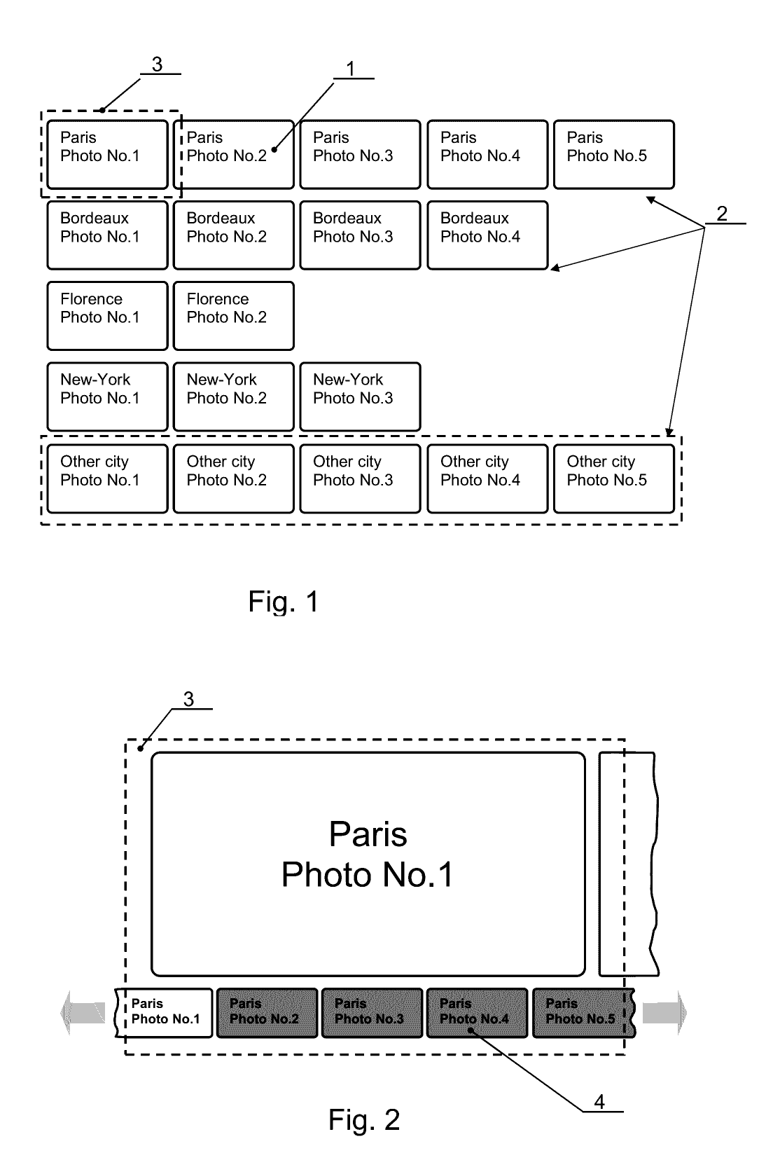

FIG. 1 shows general content organization scheme,

FIG. 2 shows content element thumbnails area,

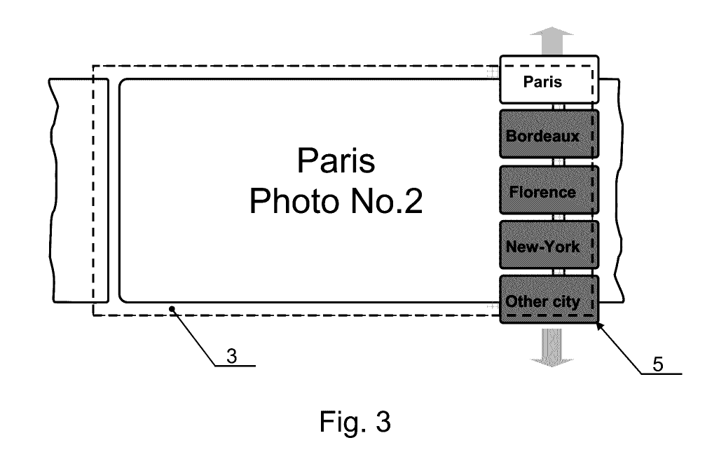

FIG. 3 shows content element group thumbnails area,

Example (FIG. 1): a person is viewing, photos (1) (hereinafter “content elements”) on his/her phone, where these photos are grouped in some directories (2) (“content element groups”). Each content element group contains content elements (1) depicting places from various cities, where content element groups (2) have the following names: Paris, Bordeaux, Florence, New York.

In existing methods, the jumping between content element groups is made using additional navigation elements (it may be: “navigation through the directory tree”, “transition through the directory located at one level higher”), which requires execution of additional operational commands. The user opens root content element group, such as “Travelling” with photos sorted by cities, enters a desired content element group, such as “Paris”, where after viewing all content elements the user must go to a content element group located one level higher in order to get to the next content element group, such as “Bordeaux”. In this case the device performs additional operational commands.

The content presentation according to this solution will be as follows: once the user opens root content element group, such as “Travelling” with content element groups and/or content elements sorted by content element groups (cities), chooses the desired content element group, such as “Paris”, the first content element is displayed on the screen, then the user starts by giving corresponding commands to scroll through these elements in one direction, for example, commands “left and right”, where the display of the content elements of the other content element group will start immediately as the user gives a scrolling command in the other direction orthogonal to scrolling direction of the content elements, in this case “up and down”.

This allows for continuous presentation of content elements on the screen (3) from different content element groups and excludes additional operational actions for navigation and presentation of the content elements from the other group.

The other embodiments of the solution provide to display additional navigation elements that are placed permanently on the screen of the electronic device and/or to hide, for example, after touching and/or automatically after a certain time of non-use, allowing filling the entire screen area with at least one content element. It is possible to leave a small area to display content element data, such as element name, creation date, file size, its location, image size, copyright information, and other useful data of the element).

Since content elements are scrolled linearly, quick transition to the content elements located, for example, in the middle of the content element group is made using additional area (4) (FIG. 2) containing reduced copies (thumbnails) of all elements in the current group and this area can be made with possibility of quick scrolling through the thumbnails.

According to this solution provides linear scrolling through the content element groups, and the quick transition to another content element group located, for example, in the middle of the list of all content element group can also be made using another area (5) (FIG. 3) containing reduced copies (thumbnails) of content element groups and this area can also be made with possibility of quick scrolling through the thumbnails.

Commands for scrolling and fast scrolling through the content elements, content element groups and thumbnail area elements may be known gestures from the prior art for navigation on the touch screen (without the cursor), and for selection of an element a quick touch or double-tap or some other prior art gesture can be used.

Scrolling through the elements and/or groups and/or thumbnails can be as follows:

“sequentially”, i.e. every user's action activates operation of scrolling (transition) to the next content element, content element group, thumbnail, where the scrolling step can be one element long or few elements long.

“accelerated”, quick scrolling mode is activated by scrolling gesture and/or tilt angle of scrolling gesture that gives a command to display element line in an accelerated mode.

scrolling with a speed that changes dynamically depending on the number of elements in the line.

scrolling with increasing speed depending on the number of accelerated scrolling gestures applied by user.

“slide show” with the desired delay interval for displaying each element where the delay time may be a fixed value and set by the user.

For convenience of “element group” viewing different methods known from the prior art that enhance perception of information may be used. Their proper combination an use improves the interaction of the user with the interface of the electronic device.

While viewing, the effects known from the prior art can be used to allay the perception of the slide changing, for instance, scrolling through the elements with a speed which set by the formula or with a certain step, such as nonlinear scrolling speed reduction gradually slowing down the movement of the content elements being scrolled after using of the accelerated scrolling gesture as they reach their final position on the screen.

The effect that simulates “elastic” positioning of the content elements upon achieving last element in the list can also be used. This allows smooth returning of the element line to optimal alignment by means of damped oscillations of the “elements”. Such effect can be used when scrolling in any direction.

In some embodiments of the solution, when reaching the last element in the line, the following operations known from the prior art can be performed:

scrolling content element groups and/or content elements and/or thumbnails in the additional area along an endless trajectory;

jumping to the content element group

output of additional navigation items, such as menu, thumbnails area, list of content element groups, display of all the content elements, search line, content element group data, hints in the form of directions of navigation gestures, etc.

further dragging of the last content element in the direction of the navigation gesture and returning it to the extreme position after completion of the action on the touch of the device.

deployment of the elements at an angle to the screen and the user.

When scrolling content elements or content element groups, the user can perform not only vertical or horizontal navigational movements, but also diagonal movements. To avoid unwanted scrolling, for example, into another content element group it is necessary to normalize such movements and, depending on the angle of navigation movement direction, to scroll in horizontal or vertical motion.

This value can be set by the user and/or set proportionally to the screen parameters given its horizontal or vertical placement, and/or selected dynamically, for example when reaching the last element the diagonal movement can be perceived as jumping to another content element group. And the perception angle can be set both in degrees and depending on the necessary conditions and the specifications of the device used.

According to this solution the jumping from the certain content element of one group to the next content element group on the screen of the device can be made to the content element with certain criteria, for example, with the same serial number of the element in the group, with the same date of creation and/or editing of the element of the same data type, element marked as “favorites” or “like”, etc. This can be useful for viewing graphics files library, where each serial number corresponds to a particular image, for viewing pictures taken in the same period of time from different photo cameras, for viewing the most successful snapshots, etc.

Scrolling content elements according to this solution can also be visualized in any convenient way:

as a standard “slider”;

as “3D slider”, namely: content elements and/or content element groups are scrolled using 3D transformation with the use of depth, volume and dynamics, such as simulating positioning of the elements on the cube faces, sphere, or deploying them at an angle to the screen;

as a “jumping through transparency” where one content element as it is dissolved displaying another content element;

According to this solution, element groups can be arranged in the form of:

flat structure—where content element groups are converted into separate lines, and the inserted content element groups are displayed in the form of additional content element lines.

inserted structure—content element groups are also transformed into lines, where inserted content element groups are displayed in the form of additional elements of the parent content element group's line.

The method according to this solution can be carried out by way of tilting electronic device and/or via single gestures and/or gestures of multiple touches, and/or with the use of at least one of the input devices, such as a keyboard, mouse, joystick, remote control.

This method can be used in desktop applications, mobile applications, operating systems, on sites (web, mobile, native, html5 and hybrid), to view pictures, video, text and other data files to be visualized. This principle of content representation can be used for online store ‘showcases’ displaying samples of goods, etc. This method can also be used in adaptive layout to ensure maximum coverage of supported devices.

This solution is described with reference to numerous specific details, but for a person skilled in the art it should be obvious that the solution can be implemented in other individual forms within the essence of the solution. It also should be obvious to a person skilled in the art that the solution is not limited to the illustrative details mentioned above and has to be determined by the formula of this solution.

Based on the aforesaid, this method is used to display any type of content elements, for example, one content element group may include pictures, videos, text and various media data simultaneously. These elements can be visualized in various ways known in the art, for example, converted into more optimized versions for comfortable viewing.

The aforesaid is the embodiment of this solution only and is not intended to limit the scope of protection.

1. A method of presenting content to the user including the following steps: definition of a set of content elements, as well as of a set of content element groups, display on the screen of the electronic device of at least one content element of, at least one content element group, scrolling the set of content elements located in a certain content element group in one direction, where the content elements from the next or previous content element group are displayed immediately after receiving scrolling command in the other direction orthogonal to scrolling direction of the set of content elements from the current group.

2. The method according to claim 1, characterized in that on the screen of the device either first element of the content of new group or element, the position of which in the group corresponds to the position of the element in the previous group, or element preselected for quick review in this group, or element, the type of which matches the type of the element of the previous group is displayed.

3. The method according to claim 1, characterized in that by scrolling content elements it occurs a normalization of diagonal navigational movements and selection of scrolling direction depending on the angle of the diagonal navigational movement.

4. The method according to claim 1, characterized in that the content element from a group of elements is displayed after its selecting by the user in additional area, in which a set of thumbnails of content elements of the current group is represented, and content element group is displayed after its selecting in another area, in which a set of thumbnails and/or names of content element groups is represented.

5. The method according to claim 4, characterized in that the thumbnail area is displayed continuously or after user's command and the thumbnails of the content elements, and the thumbnails of the content element groups, and the set of content elements, and set of content element groups is scrolled along a continuous trajectory.

6. The method according to claim 1, characterized in that the content element is displayed at least on a portion of the screen area of the electronic device, and in the rest of the screen area, it is displayed an information as to the content element or the content element is displayed on the full area of the electronic device screen, and information as to the content element is displayed upon user's request, above content element.

7. The method according to claim 1, characterized in that the set of content elements and/or set of content element groups is scrolled by tilting the electronic device, and/or by recognition of the user's single gestures and/or multiple touch gestures, and/or by using at least one of the input devices, such as keyboard, mouse, joystick, remote control, and/or by the user's voice command recognition.
